(19) United States
(12) Patent Application Publication
(10) Pub. No.: US 2024/0307804 A1
(43) Pub. Date: Sep. 19, 2024

(54) KINETIC FILTRATION DEVICE

(71) Applicant: Bastion Law, LLC, Portland, ME (US)

(72) Inventor: Thomas Law, Portland, ME (US)

(21) Appl. No.: 18/600,619

(22) Filed: Mar. 8, 2024

Related U.S. Application Data
(60) Provisional application No. 63/450,832, filed on Mar. 8, 2023.

(51) Int. Cl. B01D 39/02; B01D 15/08; B01D 24/00; B01D 24/02

(52) U.S. Cl. CPC B01D 39/02; B01D 15/08; B01D 24/001; B01D 24/02; B01D 2101/00

(57) ABSTRACT

The present invention relates to a mixed-media kinetic filtration device which uses a family of various types of media substances to enable selectable filtration and filtrate process functions. More specifically, the filtration device and related process utilizes gradient-enabled nanomechanisms to separate one or more selectable molecules from a filtrate feed and, in some cases, further process those molecules. The family of media substances may be modified, adapted, or altered through treatment, stimulation, conditioning, or other methods to create desirable characteristics and/or create different filtration or process characteristics.

### BACKGROUND OF THE INVENTION

### 1. Field of the Invention

The present invention relates to a mixed-media kinetic filtration device. More specifically, the present invention relates to the design, production, use, and life cycle management of a family of composite, bulk, aggregate, or mixed-media substances incorporating one or more process gradient-enabled nanomechanisms, referred to hereafter as bulk kinetic process media; and the modification, adaptation, or alteration of the properties and function of such a media herein.

### 2. Description of the Prior Art

Molecular sieves are permeable materials or substances that can be used to filter or isolate one or more molecular substances from a mixture of molecular substances. Current kinetic molecular sieves operate on the principle of selective physical permeability, typically size- or shape-based filtration, of specific molecules based on atomic or molecular radius. Some molecular sieves (such as palladium sieves) rely on chemical, proton, electron, electrochemical, quantum, or other transport mechanisms rather than physical permeation.

Molecular sieves are commonly employed as a membrane or similar permeable barrier or filter, where a process gradient is applied to facilitate diffusion or permeation of a substance or mixture of substances across the membrane. Molecular sieves are employed in a range of applications for chemical separation and isolation as a filter or sorbent.

Many designs for molecular sieves have been developed since the mid-20th century. Many of these designs are difficult to manufacture, use, and/or maintain.

Common problems with prior art include, but are not limited to:
Most materials used in such applications are crippled by material defects, and this is exacerbated by the difficulty of nanoscale material manufacture. The core requirement of a kinetic molecular filter is that a substance demonstrates selective permeability, excluding some substances and admitting others. Inconsistency in the void structure, placement, or alignment of such a material, the interface between such a material and other materials, or other material or manufacture defects, renders such a filter ineffective or useless.
The issues faced in molecular sieve manufacture are roughly analogous to those faced in the area of semiconductor wafer manufacture. Such filters, while practical on the small scale, have historically been difficult to manufacture and/or manufacture at larger scale—the material defects that cripple such devices can make them difficult to produce with a desired yield, and the issues of defects are often compounded the larger an individual crystal, lattice, sheet, or membrane becomes.
Many molecular sieve technologies rely on precious materials, in particular palladium and crystal formations known as zeolites. Availability and cost of these materials has been a limiting factor in proliferation and adoption of molecular filtration technologies reliant on them.
Many applications of molecular sieve technologies are limited by constraints on operating conditions for the filter material, precluding general-purpose use due to the need for controlled operating conditions to maintain filter function. For example, zeolytic sieves can quickly become clogged with water molecules when used in environments where water or water vapor traces are present, and palladium sieves are poisoned or deactivated by electrochemical reaction with commonly occurring atmospheric compounds. The useful lifetime of many molecular sieve filter technologies is limited by similar environmental considerations.
Extant filter technologies require the wholesale replacement of composite filter elements, requiring physical access to the device as well as downtime for maintenance procedures and upkeep.
Most existing filter technologies are one-use materials that are not practical to recycle or recondition without undergoing dissolution and remanufacture.
Large-scale molecular sieve manufacture is constrained by aforementioned incidence of defects in manufacturing processes, making many existing membrane and filter technologies impossible or impractical to scale to desired filter sizes.

Molecular cages, also referred to as macromolecular or supramolecular cages, are molecular structures characterized by their ability to encapsulate or otherwise mechanically contain other molecules. They are commonly embodied as approximations of nanoscale geometric polyhedra or Johnson Solid geometries. This class of molecules includes, but is not limited to, fullerines, fullerine hydrides, metal organic polyhedra (MOPs), diamondoids, and organic molecular cages (OMCs).

Porous molecular cages are molecular cages that incorporate voids, ports, holes, or openings that are large enough for other particles to pass into and/or through them via kinetic (physical transport) mechanisms and/or hybrid mechanisms. Molecular cages and porous molecular cages are understood in the art and may be created using various means, including molecular self-assembly and covalent bonding.

What is needed is a device which provides permeability by a filtration system which has a void structure and alignment of filtration material conducive to providing accurate and specific filtration of one or more filtrates. What is further needed is a filtration system which is cost-effective and able to be produced on a larger scale without requiring rare or precious metals. What is further needed is a filtration system that enables the incorporation of myriad elements and materials of various characteristics within the body of the filtration system to facilitate various functions. What is further needed is a filtration system capable of altering or modifying filtrate in-situ within the filtration system. Still further, what is needed is a method of hydrogen and other molecules filtration out of naturally arising mixtures of gasses and liquids.

### SUMMARY OF THE INVENTION

### 1. Framing and Intra-Document Definitions

In locations in this document, the term device may be used to denote a functional design, composite, mechanism, or component. This is compared to the use of media or variations on this term to denote a mass or substance, which may be used independently or incorporated into a device.

A substance or material that consists of a plurality of independent particles or elements is characterized as a “bulk”, or aggregate material or substance. Such a bulk substance generally lacks long-range or short-range order; the substance consists of particles that are more-or-less independent of one another, although they may interact via physical, chemical, electrical, quantum, or other means. This is distinct from crystalline, ceramic, polymer, or other substances or materials that demonstrate repeating structural patterns and/or bonds over longer distances. Bulk substances may approximate long-range order when compressed, vibrated, centrifuged, or otherwise induced to sift or pack together. Bulk substances may be referred to as bulk media.

A unit of one or more of molecules or particles, that when deployed in a plurality, would form a bulk substance, may be referred to as media elements.

Substances or materials that are used as a filter, sorbent, or other role where it is permeated by one or more filtrate substance in a device or composite may be referred to as process media.

Process media employed in a fashion whereby the function of the media is performed when a substance permeates the media via physical means, or by such means, prevents the movement of a substance into or through the media, may be referred to as kinetic process media. Media incorporating or facilitated by both kinetic and non-kinetic process elements, e.g., quantum, electrical, chemical, catalytic, photoreactive, electrostatic, magnetic, or other process elements, among others, may be referred to as kinetic-hybrid process media. It shall be understood that references to kinetic media and kinetic process media in this document may include kinetic-hybrid process media.

The use of a bulk substance as filter, sorbent, or other process media may be referred to as bulk process media.

A blend or combination of distinct types of process media, with or without additional blended, embedded, or surrounding materials or elements, may be referred to as heterogeneous process media; as opposed to homogenous process media consisting of a single material, substance, or type of molecule.

Process media that incorporates one or more substances, encapsulating materials, additives, fixatives, matrices, lattices, or other supporting structures or elements, in addition to bulk process media elements, where one or more host materials contains or traps bulk process media or elements of bulk process media in cavities, voids, or other supporting or constraining structures, or bulk process media or elements of bulk process media are distributed within the host material, or host media. The combination of such materials results in an overall substance or material structure that may demonstrate or approximate long-range order, may be referred to as bulk-matrix media. The terms bulk media, heterogeneous process media, and references to bulk media distributed within a host material, as used in this document, may reference bulk-matrix media.

A process gradient-enabled mechanism shall be used to refer to a device or media, or application or use of such a device or media, whereby a process gradient or differential pressure or condition is used to induce flow of one substance or mix of substances into, around, or through a device or media. Such a gradient may be static or dynamic. The gradient strength and/or direction may change over time without or within such a mechanism.

“Decorated” molecular cages are defined here to mean composite molecular cage structures that incorporate at least one central, or core, molecular cage structure, referred to here as a primary cage, and one or more functional or nonfunctional molecular side chains or molecular structures appended to the primary cage. Such side structures may be internal or external to the primary cage. Such side structures may be referred to here as decorations, moieties, substituents, inclusions, or other analogous or interchangeable terms for molecular side chains. Those skilled in the art understand there are many terms for such structures and the use of one term vs. another shall not be construed to be a limitation on embodiments of this invention. The term molecular cage used in this document shall be understood to encompass the term decorated molecular cage but does not necessarily infer the latter.

These terms will be combined in this document to denote embodiments and/or concepts incorporating features or concepts from one or more of these terms. E.g.: A blend or combination of distinct types of bulk process media, with or without additional blended, embedded, or surrounding materials or elements, whereby the combination of bulk media and other elements results in an overall structure lacking long-range order, may be referred to as heterogeneous bulk process media in this document.

### 2. Description of the Invention

It is a design of the present invention to provide a filtration system which provides selective permeability as well as function in a wide variety of operating environments. The present invention provides a method of filtration which may be more cost-effective, more accessible, more durable, and/or more versatile than current technologies. Specifically, it is a design of the present invention to filter hydrogen or other molecules out of naturally arising mixtures of gasses and liquids.

The present invention relates to a family of filtration systems with molecular filter and molecular process capabilities, improving on the design, production, use, and life cycle management of such filtration systems by introducing novel mechanisms, structures, material combinations, processes, and more to improve function, manufacturability, usability, maintenance, performance, capability, deployment, and recovery of substances and devices incorporating bulk kinetic process media, including but not limited to heterogenous and interface-enabled bulk substances and bulk substances incorporating one or more active or reactive embedded elements or components. It is a goal of the present invention to provide the selective filtration and/or modification of various molecular substances, including but not limited to, the filtration and/or lysis of hydrogen from atmospheric, aquatic, or other environments.

Those skilled in the art will realize that there may be variations of the invention and embodiments described in this document, including alternate or equivalent molecular materials, configurations, host materials, deployments, applications, manufacture strategies, and other factors. The specific terms and notations used in the present application represent typical technical terms in the field but may be construed differently in other references. Additionally, as the technological field is rapidly progressing, there may be multiple or conflicting terms that refer to the same, or related concepts; or differences in definitions of concepts, materials, and structures are immature or fluid, or may not yet be defined. In particular, embodiments of this invention that may be constructed of materials or structures not specifically referenced in this document due to terminology. Where possible, the author has referred to the function, role, or relevant characteristic of a material in this document. Specific concepts, substances, materials, categories, and technical terms for demonstrably similar concepts, structures, or materials, and categories have been included only as reference or examples and the invention should not be construed as limited to only the concepts described herein.

### BRIEF DESCRIPTION OF THE DRAWINGS

FIG. 1 is a front perspective view of a porous molecular cage of the present invention.

FIG. 2 is a depiction of a mixture interacting with a porous molecular cage to produce a filtrate.

FIG. 3a is a front perspective, three-dimensional view of a plurality of forms of molecular cages.

FIG. 3b is a front, two-dimensional view of a plurality of forms of molecular cages.

FIG. 4a is a molecular view of an organic molecule depicting the attachment of decorations.

FIG. 4b is a depiction of the molecular structure of an organic molecule with attached decorations.

FIG. 4c is a simplified view of the molecular structure depicting a plurality of pores and a plurality of decorations.

FIG. 5 is a depiction of a mixture interacting with a porous molecular cage whereby the porous molecular cage retains the filtered material.

FIG. 6 is a depiction of a plurality of bulk media elements, forming the bulk media.

FIG. 7 is a depiction of the bulk media comprising of a plurality of layers of bulk media elements.

FIG. 8 is a depiction of the bulk media comprising of a plurality of layers of bulk media elements with selective filtrate flow along bias channels.

FIG. 9a is a depiction of the bulk media comprising of a plurality of bulk media elements.

FIG. 9b is a depiction of a second bulk media element of the bulk media.

FIG. 9c is a depiction of a third media element of the bulk media.

FIG. 10 is a depiction of a porous molecular cage with a plurality of pores.

FIG. 11 is a depiction of a porous molecular cage with an encapsulated element.

FIG. 12 is a depiction of a mixture interacting with a porous molecular cage with an encapsulated element producing a plurality of filtrates.

### DETAILED DESCRIPTION OF THE INVENTION

The present invention relates to the use of decorated or non-decorated molecular, macromolecular, or supramolecular cages (or fractions, derivations, or composites thereof, which shall also be referred to in this document as molecular cages) as a functional unit, or elements of a functional unit, or sorbent element, in process media. These molecular cages serve as a nanoscale porous material. The pores or openings, or in some cases, lack thereof, serve to allow some molecules or substances to perfuse through them, or through the resulting bulk material, while blocking admission of other molecules or substances.

Such media can be used in process gradient-enabled mechanisms or devices where molecular cages serve to facilitate the function of the process media or device. Such devices and embodiments span a spectrum of complexity. Embodiments of the present invention include multidimensional heterogeneous kinetic process pipelines, kinetic process media incorporating active and reactive embedded components, kinetic process devices that are continuously and/or intermittently conditioned or processed themselves, and more as described in this invention.

A mass of such molecular cages may be composed of identical cages or cages with different characteristics, or other embedded or admixed elements, resulting in either a uniform, or homogeneous, bulk media, or a mixed, or heterogeneous, bulk media. Said bulk media may be single-layered or multi-layered, and molecular cage elements and/or other bulk elements or components may be intentionally layered, oriented, aligned, misaligned, mixed, or otherwise placed so as to bias or influence the flow or path that a filtrate takes through the overall media or otherwise alter the function of the media or regions of the media.

Said molecular cages may be physically constrained or unconstrained as appropriate for a given embodiment of this invention. They may be fixed, sandwiched, affixed, stabilized, cemented, supported, or otherwise mechanically influenced by other materials when used in bulk-matrix process media embodiments, interface-enabled embodiments, or bounded bulk media embodiments. Such constraining, supporting, or host materials include but are not limited to crystals, matrices, lattices, nets, meshes, films, foams, plastics, ceramics, zeolites, metal-organic frameworks, oxides, liquids, covalent organic frameworks, schwarzites, and polymers, among others. In some embodiments, the host material or structure may interact with, facilitate the function of, or alter the properties or function of the bulk materials they contain or bound. In one or more embodiments, one or more interactions at the interface(s) between one or more host materials and one or more bulk materials may result in interface-enabled bulk-matrix process media. In one or more embodiments, different regions of a contiguous piece of host material may contain different types of bulk media.

In one or more embodiments of this invention, molecular cage structures or host materials described in this invention may encapsulate other bulk elements, particles, substances, materials, or devices in addition to any permeating filtrate or filtrates. Such trapped or contained structures may be incidental or intentional and may include other molecular cages or fractions of molecular cages, trapped ions, crystals, cocrystals, molecules, reactive elements, catalysts, enzymes, coordination complexes, kinetic catalysts (including but not limited to diruthenium bridge complexes), or other bulk elements. Such elements may facilitate and/or prevent permeation of one or more filtrate substances. Such elements may be assembled or otherwise created within the media from filtrate substances, decorations or elements of molecular cages, interactions with radiated particles and/or waves, or other precursors or available elements.

In some embodiments of this invention, molecular cage precursors may be employed within process media to form molecular cages in-situ. These cages and/or precursors may be independent in the larger mass, encapsulate other bulk media elements, or be encapsulated themselves by other elements.

A bulk of molecular cages may be seeded, placed, enclosed, encapsulated, or physically contained or constrained by any number of physical structures proscribed or implied by this invention, which may facilitate the function of the molecular cages as sorbent or filter elements within the media. Those skilled in the art will realize that there are a multitude of physical structures that can contain or influence their contents, in this case molecular cage molecules. Such host materials or host media may be necessary to constrain or direct the flow of substances through the bulk process media, aid in the characteristics and capabilities of such a device, and may interact directly with contained bulk media through interfaces, anchors, interactions, and other mechanisms.

In one or more embodiments of this invention, the host media may be a matrix, lattice, network, mesh, or similar structure that provides mechanical or other boundaries or interfaces that constrain, clump, encapsulate, or otherwise mechanically restrict one or more molecular cages into voids or spaces within the matrix or lattice, to mechanically support or otherwise alter the attributes or function of the bulk media or bulk media elements within the host matrix, in the fashion described in this document as a bulk-matrix kinetic process media. Such bulk-matrix process media may be incorporated into kinetic and/or kinetic-hybrid process devices as described by this invention. Such bulk-matrix process media may demonstrate emergent properties and/or process functions as a result of the interaction of one or more bulk media elements or components, and/or one or more aspects of the host media structure, and/or the action of one or more filtrate particles within the bulk-matrix process media, resulting in interface-enabled bulk-matrix process media.

In one or more embodiments of this invention, substances, materials, or elements other than molecular sieves may be mixed, admixed, or embedded in bulk process media containing a plurality of molecular sieve elements.

In one or more embodiments of this invention, one or more active or reactive components, elements, catalysts, or other substances, media, or devices are embedded or admixed in bulk process media and/or encapsulated by bulk media elements. Active or reactive components may provide or respond to electrical, chemical, thermal, kinetic, nuclear, radiated emissions, photo, radio, quantum, electromagnetic, pressure, temporal, wave-based, molecular, or other stimulus or phenomena. Components may be structurally formatted to capture or release or otherwise interact with filtrate, media elements, media precursors or byproducts, or other substances or materials.

This invention includes the use of such components within or adjacent to a mass of bulk process media to facilitate or alter the function of the overall sorbent or bulk process through influence of the component, or the behavior, actions, or reactions, of the component within the media, whereby the component or components alter the function of the bulk media, regions of the bulk media, or the elements of the bulk media for any period.

Active or reactive components may generate or be triggered by any combination of stimuli and may generate or react to patterns of stimuli. Embedded active or reactive components may include simple or complex devices, electronics, and structures incorporating mechanisms and/or logic. Such components may produce reactions or stimulus that reach beyond the bounds of the bulk media and may be interpreted by external means to reflect the internal state, attributes, or function of the bulk media, or portions of the bulk media.

Molecular cages incorporated in such a device or media may be decorated with additional functional or nonfunctional molecular structures to facilitate or alter the function of some or all of the molecular cages within the substance. Said decorations may be reactive or nonreactive and may be added or removed from cages during manufacture or use, with or without impacting the ability of a decorated cage to function as an element of the bulk process media. Such decorations may serve to enhance or restrict the permeability of a porous molecular cage. The decorations may also serve as an anchor or mechanical interface for other molecular cages, host materials, admixed components, or bounding structures, interfaces, or components. Decorations may serve to provide additional active or reactive capabilities or attributes for individual molecular cages, the bulk media as a whole, or portions of the bulk media.

In addition to the physical structure of a bulk kinetic process material, the use of individual and/or grouped molecular cages, elements, and admixed components enables improved procedures and processes for process media that are impossible or difficult with prior materials.

The present invention may optionally have the ability to add and/or remove one or more molecular cage(s), masses of bulk-matrix media, or one or more admixed components or elements from a mass of bulk process media, or masses of bulk-matrix media, to alter or modify the function of the media or device in situ, with or without necessitating the replacement, deconstruction, removal of a mass of media or a composite device. In one or more embodiments of this invention, bulk media elements or embedded components may be assembled within the bulk process media from filtrate, embedded precursors, and/or other precursors or stimuli.

Bulk media elements or embedded components, or portions, fractions, combinations, or derivations thereof, removed from a mass or bulk process media, may be recovered, reconditioned, recycled, sorted, washed, or otherwise reconditioned for reuse after use in and subsequent removal from a bulk process media. In one or more embodiments of this invention, bulk media elements or embedded components, or portions, fractions, combinations, or derivations thereof, may be passed through regions of the bulk media as filtrate.

In one or more embodiments of this invention, filtrate flow bias channels or regions may be incorporated into, or arise within, the overall body of bulk process media. Such flow bias channels may impact the movement of substances as they move through the overall body of the bulk process media, in such a way as to facilitate, restrict, stop, bias, direct, accelerate, limit, or otherwise influence the flow of one or more substances, filtrates, or filtrate fractions through said media or portions of said media. Such flow bias channels may consist of voids, channels, heterogeneous bulk media elements, geometrically arranged bulk media elements, embedded components, or heterogeneous regions of the overall bulk media. Flow channels may be introduced, induced, or arise at any point in the bulk media lifecycle, including but not limited during manufacture, maintenance, or during use via the application of active or reactive elements embedded within a mass of process media, or by the application of stimulus to the media, including but not limited to differential electrical potential or current, physical manipulation, or gravitational forces. Such channels may be introduced or formed by interaction with filtrate flowing through the media. Such channels may be used to isolate, separate, or direct one or more filtrate fractions from a mixture of permeating filtrate elements, e.g. the separation of air into constituent gases, or mixtures of gases, including but not limited to oxygen, nitrogen, water, hydrogen, and other elements; or the separation of mixed aqueous solutions including but not limited to seawater into fractions by kinetic or kinetic-hybrid means.

In certain embodiments, some or all of these design elements are combined into a composite kinetic or kinetic-hybrid process media or process device capable of altering or modifying one or more filtrate substances that interact with regions of the media, resulting in one or more product or byproduct filtrate substances. These product, derivative, or byproduct filtrate substances may or may not be further altered or modified within the kinetic process media or device, or by processing through a subsequent process, including additional layers or structures of kinetic process media, or additional kinetic process devices. Filtrate, filtrate precursors, and/or filtrate products may influence or alter the functioning of the overall process media or portions of the process media.

The invention utilizes a molecular filter design, with the introduction of novel mechanisms, structures, material combinations, and processes to improve function, manufacturability, interaction, and recovery of substances and devices incorporating bulk kinetic process media, including heterogenous and interface-enabled bulk substances and bulk substances incorporating one or more reactive elements. The novel mechanisms, structures, and processes improve upon existing molecular filter methods.

Advantages of the present invention over prior art include but not limited to,
This technology enables the selective separation of filtrate elements from one another in a sequential and/or parallel fashion, including but not limited to the ability to direct filtrate fractions in different directions from one another within and/or adjacent to the boundary of such a device or media.
This technology enables the creation of single- and multi-stage kinetic and kinetic-hybrid process media capable of manipulating or altering filtrate substances and resultant filtrate products as they flow through the media through kinetic, kinetic-hybrid, and/or other mechanisms.
   For further clarity, this technology enables, but does not require, the isolation, separation, and/or concentration of zero or more filtrates from a mixture of input filtrates into sub-regions of the device, media, or output flows from of such a device or media.
   For further clarity, this technology enables the alteration of filtrates within the body of or at the boundary of such a device or media.
   For further clarity, this technology enables multiple stages of filtration, separation, and modification of filtrates, and in some embodiments, enables multiple stages within the body of a single device or process media.
   For further clarity, this technology enables both the selective separation and the alteration of molecular substances as they permeate or flow through such a device or media, including but not limited to separation or concentration of filtrate molecules such as water from other filtrates, followed by catalysis of filtrate molecules such as water into constituent elements, such as hydrogen and oxygen, and then further separating the resulting filtrates or constituent elements, resulting in concentrated streams or flows of the constituent element filtrates, such as separate streams of hydrogen, oxygen, and other filtrates, in various mixtures or concentrations.
This bulk process media technology, and the lifecycle management processes described in this invention, in combination, enable the creation of nanoscale process environments.
Ease of Manufacture—producing large quantities of molecular cages with low rate of defects at scale may be more efficient than producing flawless monomolecular or nanoscale membranes or sheets at scale. Sorting and inspection mechanisms, described in this document, can be used to isolate desired molecular cage structures from even low-yield or inefficient molecular cage manufacture processes.
Ability to shed or remove clogged, poisoned, or otherwise nonfunctional portions of the bulk process media to rejuvenate or alter process media function without removing or replacing the media or device altogether. This feature may also allow for portions of the device to be selectively replaced.
Device scalability—as many embodiments of this invention do not require flawless or near-flawless nanoscale membranes or sheets, practical macroscale devices consisting of a plurality of molecular cages and other bulk media, bulk-matrix, admixed or embedded elements, and host materials may be realized.
Element Modifiability—bulk media elements (individual molecules or components) may be individually modified in ways to alter the characteristics of the bulk media or regions of the bulk media without impacting the manufacture or aggregate structure of other media elements, or heterogeneous bulk media or devices containing such media. For further clarity, portions of such media or a device containing such media may be altered while maintaining an overall similar structure and design of the media or device.
Ability for filtrate flow bias—in one or more embodiments of this invention, media may be layered, mixed, or otherwise assembled or organized in such a way as to influence the flow of one or more filtrate substances within the body of the media. This enables the creation of multidimensional flow-bias kinetic process mechanisms and devices capable of isolating and/or combining one or more filtrate substances within the body of the media or device. Design and manufacture of both simple and complex filtrate flow bias networks within a body of bulk media may be more practicable in many cases than methods available with extant technologies and strategies such as crystalline plane alignment.
Non-Reactivity—One or more embodiments of this invention employ process media incorporating carbon or silicon molecular cages, or other insulator or nonreactive molecular cage elements, in formations that do not typically chemically react with commonly occurring substances, and are not prone to filter poisoning or deactivation. In addition to the performance of such materials, this characteristic may be used to insulate, or otherwise facilitate the function of, elements or components that would otherwise be susceptible to such reactions.
Molecular cage encapsulation or removal of target materials—the mechanism described in this invention whereby, in addition to separation of a filtrate by kinetic means, molecular cages deployed in such media or device may be designed to allow one or more filtrates to penetrate and then become entrapped within the body of a molecular cage by interaction with an internal decoration, trapped element, or filtrate substance, and/or other interaction, restricting movement of said filtrate within the larger body of media. Such trapped filtrate may be removed from the media at a later time.
Ability to operate and maintain filtration and/or processing function in loosely controlled, chaotic, or natural environments, including but not limited to natural atmospheric, aquatic, oceanic, or other uncontrolled or loosely controlled gas or liquid process conditions that would render prior technologies inoperable, impractical, or inefficient due to clogging, poisoning, and/or other operational or environmental factors.
The deployment of molecular cages and/or other bulk media elements within a lattice structure, and the resulting interface-enabled kinetic process media provides many advantages over prior art, including:
   Where the cupping or other mechanical interaction or support of one or more bulk media elements (interface-enabled) improves the filtering function of the bulk media.
   The use of molecular cages within voids in bounding structures allows for such media to be cleared or unclogged by modifying or reversing a process gradient in such a way as to shift or alter the position of the bulk elements within the voids of the matrix.
   The use of a matrix, or negative-curve matrix in such a filter, in combination with embedded bulk media elements, allows for improved selectivity and filtrate bias characteristics, whereby non-selected filtrates are biased, or induced to flow outward in a direction away from the flow of one or more selected filtrates, with less clogging or reduction in the filter action of the media.

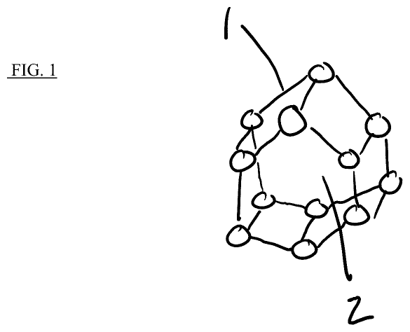

As depicted in FIGS. 1-12, the present invention is a filtration device formed of a plurality of molecular cages 1. Each molecular cage 1 establishes a void 2. The cage 1 may also have a plurality of pores 20 and decorations 17. The present invention is configured to interact with a mixture 24 having a plurality of molecular permeates, whereby the present invention may selectively filter the molecular permeates from the mixture, creating a plurality of filtrates 25.

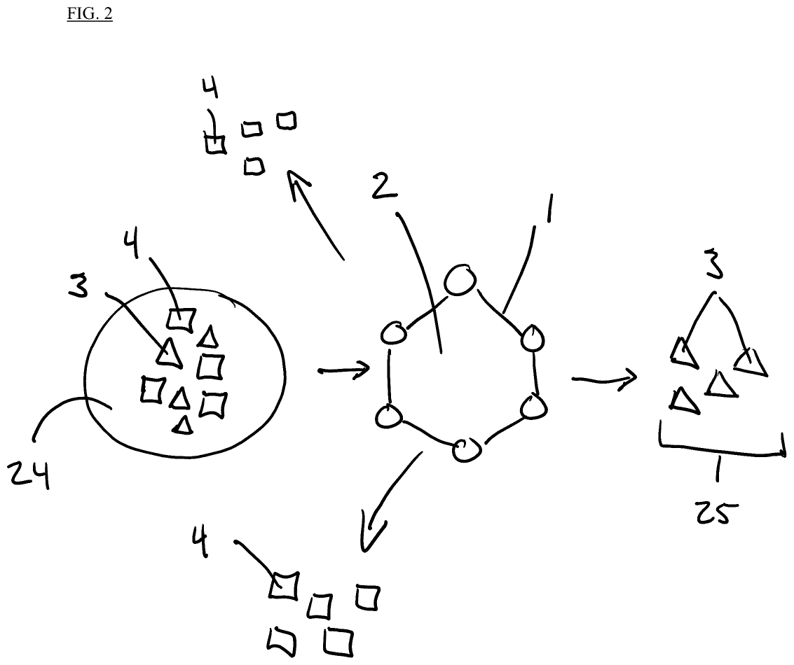

FIGS. 1-2 depict a single molecular cage 1 of the present invention. The void 2 of the molecular cage 1 provides a method of passage whereby the mixture 24 may pass through the cage 1. The mixture 24 may contain a first molecular permeate 3 and a second molecular permeate 4. As the mixture passes through the void 2 of the molecular cage 1, the molecular cage 1 may be selectively configured to filter the first molecular permeate 3 and the second molecular permeate 4 to separate them from one another.

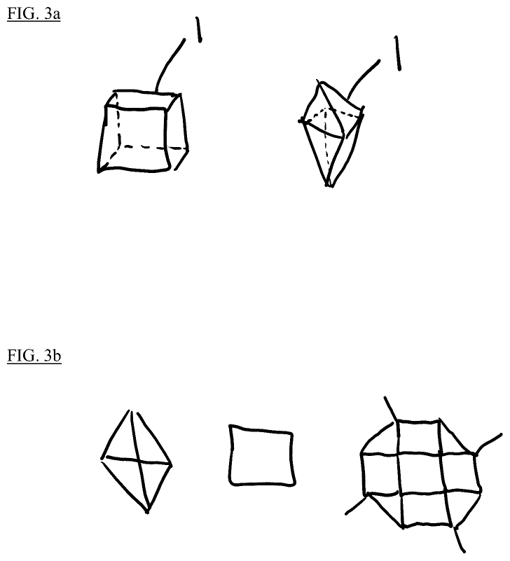

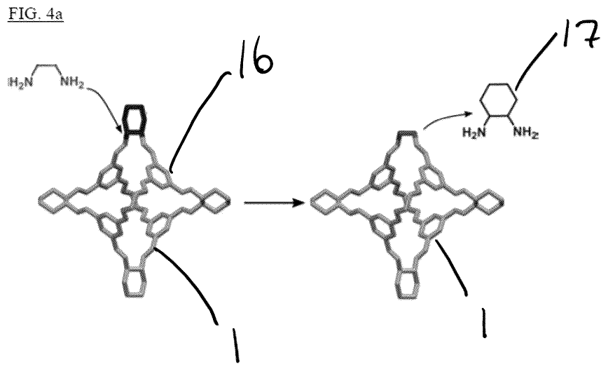

FIGS. 3a-3b depict a variety of configurations of molecular cages 1. The cages 1 may be aligned to selectively target molecular permeates based on chemical or mechanical means. Various forms of molecular cages 1 may be utilized in a single formation to provide varying filtration characteristics.

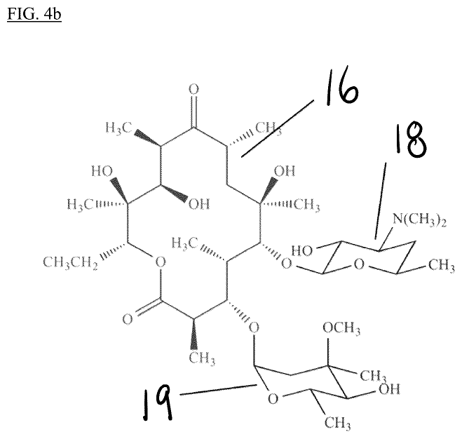

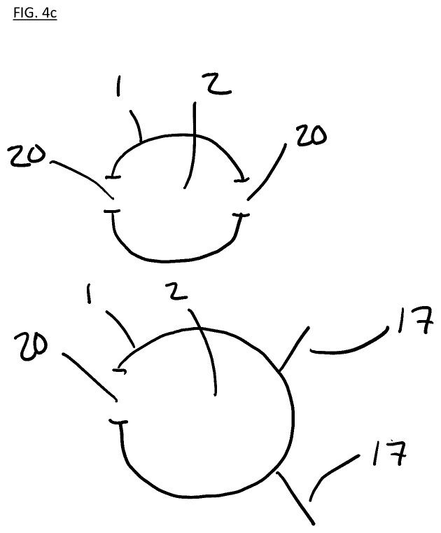

FIGS. 4a-4c depict representations of the molecular cages with decorations 17 or pores 20. FIG. 4a depicts a molecular cage structure 16 showing the molecular formation of the cage 1 with a decoration 17. The decorations 17 are chemical compound attachments selected to change the filtration functionality of the cage 1. FIG. 4b depicts the molecular cage structure 16 with a first decoration 18 and a second decoration 19. The molecular cage structure 16 may be selectively aligned with decorations 17 to produce the desired filtration characteristics. FIG. 4c depicts a molecular cage 1 with two pores 20 and an embodiment of the molecular cage 1 with a single pore 20 and two decorations 17. The pores 20 allow for movement of the mixture 24 or filtrate 25 through the molecular cage 1. The decorations 17 change the chemical or mechanical structure of the cage 1 to achieve selective filtration characteristics dependent on the desired filtrate or filtrates from the mixture 24. The cage 1 may be equipped with a variable number of pores 20 and decorations 17. The pores 20 may be homogenous or heterogenous. The decorations 17 may be homogenous or heterogenous. The number and type of pores 20 and decorations 17 may be adjusted or utilized as desired to provide selective filtration characteristics.

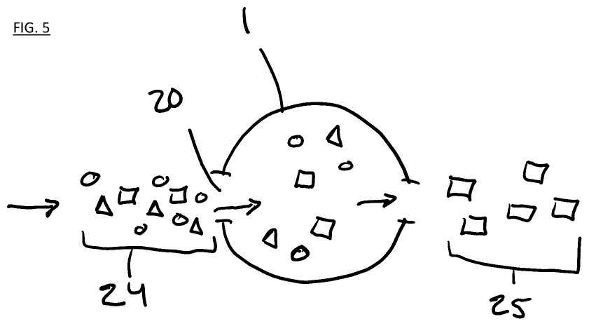

FIG. 5 depicts the molecular cage 1 with the mixture 24 passing through a pore 20 of the cage 1 into the void of the cage 1. The properties of the cage 1 selectively filter a plurality of molecular permeates from the mixture 24, producing the filtrate 25. The cage 1 may retain the filtered molecular permeates within the void 2 of the cage 1 or may expel the filtered permeates through another of the pores 20.

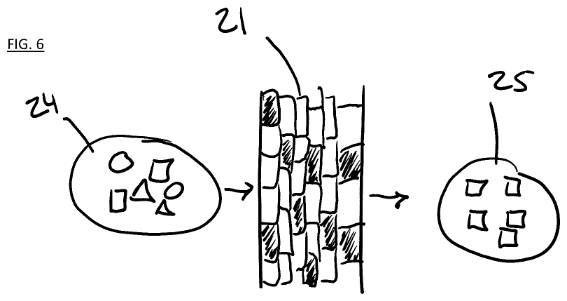

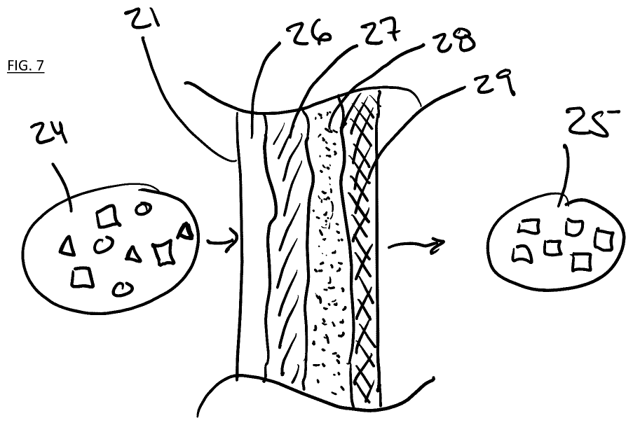

FIGS. 6-7 depicts the present invention configured as a layered bulk media 21. The bulk media 21 is made of a plurality of molecular cages 1. The molecular cages 1 may be aligned together to form layers of cages 1. FIG. 6 depicts the mixture 24 passing through the cages 1 of the bulk media 21 to produce the filtrate 25. The layered bulk media 21 may be utilized to provide varying filtration characteristics. For example, if a mixture contains permeates A, B, and C, one layer of molecular cages may selectively filter permeate A and another layer of molecular cages may selectively filter permeate B. As the mixture passes through the layers, permeates A and B are filtered by the various layers, resulting in a filtrate of permeate C to pass through the entire media 21 of the filtration device.

An embodiment of the bulk media 21, as depicted in FIG. 7, has a first layer 26, a second layer 27, a third layer 28, and a fourth layer 29. The layers may be aligned homogenously or may be mixed together, depending on the desired filtration characteristics. Each of the individual layers 26-29 may be selectively designed to provide a specific filtration characteristic, such as targeting the filtration of a certain molecule. The bulk media 21 may be configured with various combinations of bulk matrix media.

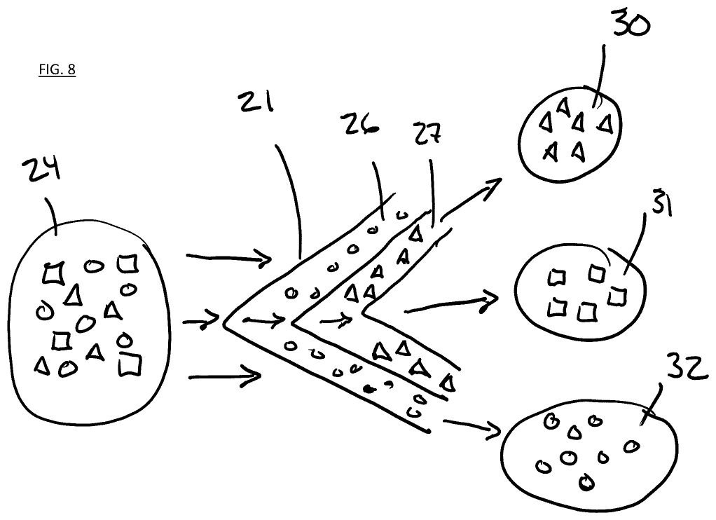

FIG. 8 depicts an embodiment of the layered bulk media 21 configured to provide bias flow-through channels. The layers 26, 27 may be aligned to create bias flow channels in which a selective permeate may be filtered from the mixture 24 and directed through the desired channel. As depicted in FIG. 8, a first filtrate 30, a second filtrate 31, and a third filtrate 32 may be created based on the bias flow channels created by the layers 26, 27 of the bulk media 21.

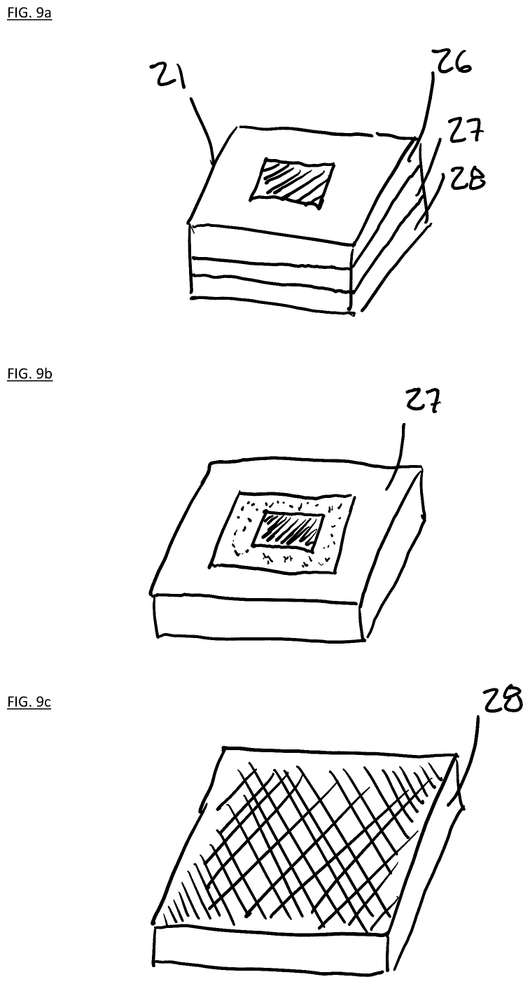

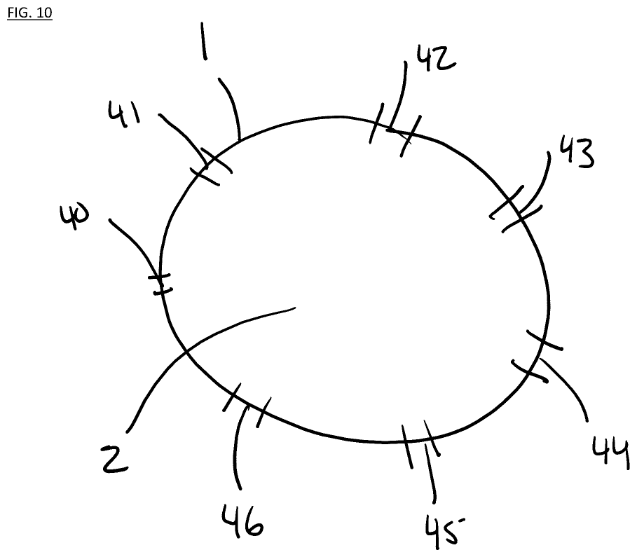

FIG. 9a-9c depicts an embodiment of the layered bulk media 21 configured in a linear fashion. The layers 26, 27, 28 may be aligned such that the passage of the mixture 24 passes through the layers to provide selective filtration. FIG. 9a depicts the bulk media 21 with three layers 26, 27, 28 whereby the first layer 26 has certain selectable filtration characteristics. FIG. 9b depicts the second layer 27 of the bulk media 21 having certain selectable filtration characteristics that may be different from those of the first layer 26. FIG. 9c depicts the third layer 28 of the bulk media 21 having certain selectable filtration characteristics that may be the same as or different from either or both of layers 26 and 17.

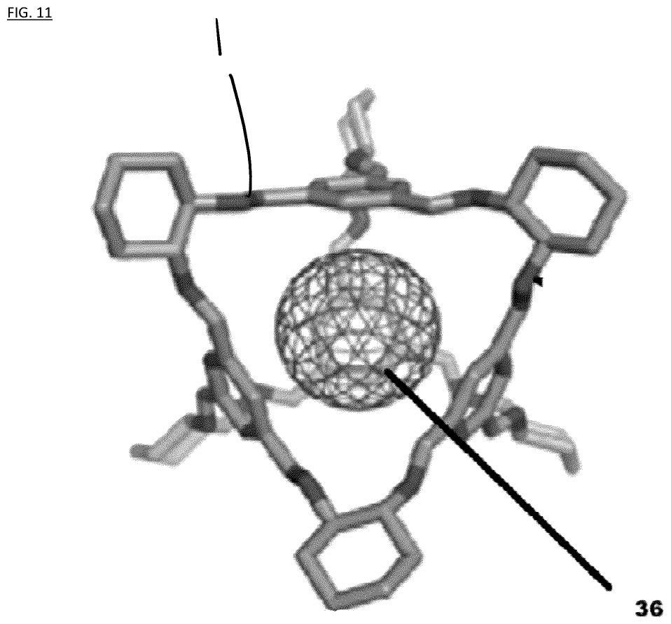

FIG. 10 depicts the molecular cage 1 having a first pore 40, a second pore 41, a third pore 42, a third pore 43, a fourth pore 44, a fifth pore 45, and a sixth pore 46. The pores 40-46 may be designed to have varying characteristics to interact with the mixture 24 to provide selective filtration characteristics.

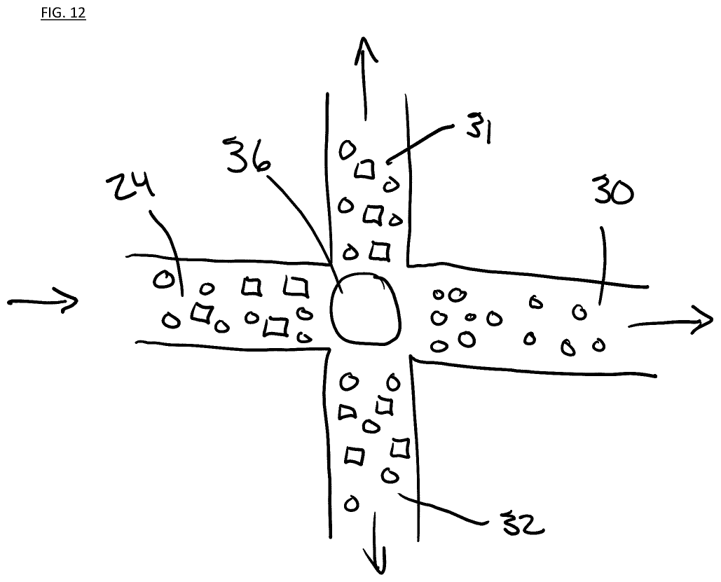

FIGS. 11-12 depict the molecular cage 1 with an encapsulated element 36. The encapsulated element 36 may provide selective filtration characteristics whereby the permeates are diverted or directed as a method of filtration. As depicted in FIG. 11, the encapsulated element 36 is located within the void 2 of the molecular cage 1. As the mixture 24 passes through a pore 20 into the void 2 of the molecular cage 1, the encapsulated element 36 may interact with the permeates within the mixture 24 to provide selective filtration. As depicted in FIG. 12, the mixture 24 interacts with the encapsulated element 36. The encapsulated element 36 selectively filters permeates creating a first filtrate 30, a second filtrate 31, and a third filtrate 32. The encapsulated element 36 utilizes the gradient flow of the mixture 24 to provide a kinetic or kinetic-hybrid interaction to selective filter permeates.

In one or more embodiments of this invention, a plurality of porous molecular cages, with or without other admixed or embedded elements or components, are grouped into bulk process media.

In one or more embodiments of this invention bulk process media is placed or packed into a space in such a manner that free space around the elements of the media is effectively blocked.

In one or more embodiments of this invention, a natural or artificial process gradient induces preferential flow of a filtrate through the media or device when a suitable filtrate capable of penetrating the kinetic process media is present.

In one or more embodiments of this invention, bulk process media is supported or held in place within a device or design by one or more boundary materials.

In one or more embodiments of this invention, bulk process media is supported or held in place within a device or design by one or more solid host materials, creating bulk-matrix process media.

In one or more embodiments of this invention, bulk process media is supported or held in place by the pressure of bounding liquids, gases, plasmas, or other motile states of matter.

In one or more embodiments of this invention, portions of the bulk process media are cemented or affixed at one or more boundaries of the bulk media.

In one or more embodiments of this invention, bulk process media is composed of one or more unique or distinguishable types of bulk elements and/or embedded components.

In one or more embodiments of this invention, bulk media elements are doped or seeded into a host media or surrounding matrix.

In one or more embodiments of this invention, bulk media elements are assembled in place within the cavities of a host media or matrix.

In one or more embodiments of this invention, bulk process media elements are seeded into or assembled within a carbon or silicon schwarzite or similar porous negative-curve matrix material.

In one or more embodiments of this invention, bulk process media elements are seeded into, or assembled within a zeolite, ceramic, crystalline, metal organic framework, covalent organic framework, porous organic polymer, or similar porous amorphous or porous matrix material.

In one or more embodiments of this invention, molecular cages are doped or seeded into carbon or silicon nanotubes or fractions of carbon or silicon nanotubes.

In one or more embodiments of this invention, bulk process media may be doped or seeded into liquid or plasma host materials, creating a porous liquid or porous plasma bulk process media.

In one or more embodiments of this invention, molecular cages may encapsulate trapped molecules (including other molecular cages), trapped atoms, or trapped ions.

In one or more embodiments of this invention, molecular cages may encapsulate or insulate trapped proton transport facilitator particles.

In one or more embodiments of this invention, molecular cages may be decorated with various additional molecular structures, internal or external moieties, or inclusions that alter or facilitate the properties of said cages.

In one or more embodiments of this invention, multiple types of molecular cages may be mixed together into a heterogenous aggregate.

In one or more embodiments of this invention, heterogenous bulk process media may consist of elements with contrasting reactive properties, such as intentional thermal mismatch characteristics.

In one or more embodiments of this invention, one or more types of molecular cages may be mixed with one or more other substances into a heterogenous composite.

In one or more embodiments of this invention, one or more types of molecular cages or other substances may be arranged in various layers, regions, channels, or other sub-regions or structures within the media.

In one or more embodiments of this invention, elements of a bulk substance may be modified or activated in-situ by use of stimulus, reaction, decay mechanism, gradient, or other means to alter the size, shape, function, linkage, chemical or mechanical connection, or other properties of said molecular cages.

In one or more embodiments of this invention, stimulus elements embedded in a substance may provide a stimulus, reaction, decay mechanism, gradient, or other means to alter the size, shape, function, linkage, chemical or mechanical connection, or other properties of bulk filter materials in-situ.

In one or more embodiments of this invention, the molecular sieve substance or filter may be used as a one-sided filter or adsorbent bed for the capture and release of molecular substances.

What is claimed is:

1. A kinetic filtration device for the filtration of certain molecules from a mixture, the device comprising:
a bulk kinetic process media having a plurality of components; and
a plurality of molecular cage elements;
wherein the plurality of elements and/or components of the bulk kinetic process media are aligned such that the mixture passes through the bulk kinetic process media in a directional fashion; and
wherein the plurality of elements and/or components of the bulk kinetic process media direct certain molecules of the mixture in an intentional method in relation to the filtrate.

2. The device of claim 1 wherein the bulk kinetic process media is comprising of heterogenous or homogeneous elements.

3. The device of claim 1 wherein the elements or components of the bulk kinetic process media are layered, blended, deposited, seeded, assembled, or otherwise intentionally located within the bulk kinetic process media.

4. The device of claim 1 wherein the bulk kinetic process media device is configured to removably receive quantities of bulk elements or components.

5. The device of claim 1 wherein the elements or components include embedded or admixed active or reactive components, catalysts, catalyst precursors, or other substances.

6. The device of claim 1 wherein a region of the process media is arranged or aligned so as to encapsulate one or more filtrate substances.

7. The device of claim 1 wherein one or more molecular cage elements are decorated molecular cages wherein the decorations alter the function of the bulk media process.

8. The device of claim 6 wherein the elements or components of the decorated molecular cages mechanically interact with other molecular cage elements, host materials, or interface materials.

9. A process in which a kinetic filtration device is formed, the process comprising of the steps of:
selecting a plurality of components;
aligning the components in a formation; and
affixing the components forming a bulk kinetic media process;
wherein the components are selected based on a plurality of filtration characteristics to selectively interact with molecules of the filtrate substances; and
wherein the formation is such that the filtrate substance passes through the components of the bulk kinetic media process.

10. The process of claim 9 wherein the elements or components are moved, removed, agitated, destroyed, abated, decomposed, conditioned, or otherwise to alter the multitude of characteristics of the bulk kinetic media process to selectively interact with filtrate molecules.

11. The process of claim 9 wherein a plurality of elements or components are selectively added to bulk kinetic media to alter the function of the bulk kinetic media.

12. A bulk-matrix kinetic filtration device for the filtration and/or process of certain molecules from a mixture of molecules, the device comprising:
a bulk kinetic process media having a plurality of components;
a plurality of molecular cage elements; and
a structure;
wherein the plurality of components of the bulk kinetic process media are aligned such that the mixture passes through the bulk kinetic process media in an intentional method;
wherein the plurality of components of the bulk kinetic process media direct certain molecules of the mixture in an intentional method in relation to the filtrate;
wherein the bulk elements or components are retained within voids in a host matrix;
wherein the structure provides alignment and support of the bulk kinetic process media.

13. The device of claim 12 wherein the one or more components of the bulk kinetic process media are assembled in a selective manner within the structure.

14. The device of claim 12 wherein the structure is formed of a framework such as a schwarzite, zeolite, metal organic framework, covalent organic framework, or other type of framework.

15. The device of claim 12 wherein the bulk-matrix structure has a plurality of regions having selectable void structure, size, density, distribution, and other characteristics wherein said characteristics alter the function of the bulk process media.

16. The device of claim 12 wherein the elements or components of the bulk kinetic process media are affixed within or interact with the structure by mechanical means, molecular cage decoration means, or other structural means.

17. The device of claim 12 wherein the interaction between the host and bulk media materials and/or the filtrate substances results in an emergent processing property, resulting in interface-enabled bulk matrix kinetic process media.

18. The device of claim 12 wherein the device may contain multiple distinguishable regions of bulk process media demonstrating various process characteristics.
